(19) United States
(12) Patent Application Publication
(10) Pub. No.: US 2024/0256972 A1
(43) Pub. Date: Aug. 1, 2024

(54) METAMODEL AND FEATURE GENERATION FOR RAPID AND ACCURATE ANOMALY DETECTION

(71) Applicant: VISA INTERNATIONAL SERVICE ASSOCIATION, San Francisco, CA (US)

(72) Inventors: Xiao Tian, Austin, TX (US); Chiranjeet Chetia, Round Rock, TX (US); Yuege Xie, San Francisco, CA (US)

(73) Assignee: VISA INTERNATIONAL SERVICE ASSOCIATION, San Francisco, CA (US)

(21) Appl. No.: 18/561,630

(22) PCT Filed: May 27, 2022
(86) PCT No.: PCT/US2022/031412

§ 371 Date: Nov. 16, 2023

Related U.S. Application Data
(60) Provisional application No. 63/194,787, filed on May 28, 2021.

(51) Int. Cl. G06N 20/00

(52) U.S. Cl. CPC G06N 20/00

(57) ABSTRACT

Methods and systems for quickly and accurately training machine learning models to perform tasks related to new contexts are disclosed, particularly new contexts for which there is little available training data. One or more source data sets can be divided into a plurality of source sub-sets, which can be used to train a plurality of source sub-models. From this plurality of source sub-models, an estimate parameter set can be determined. The estimate parameter set and a target data set (which may comprise a comparatively small number of data elements) can be used to train a target model to perform some task. In this way, the source data set can be leveraged to train the target model. Additionally disclosed is a novel method of generating color maps, image representations of non-image data. These color maps can be used to train the sub-models and target model, improving model performance.

### CROSS REFERENCE TO RELATED APPLICATIONS

This application is an international patent application which claims the benefit of the filing date of U.S. Patent Application No. 63/194,787, filed May 28, 2021, which is herein incorporated by reference in its entirety for all purposes

### BACKGROUND

In the field of data analysis, machine learning can be used to accomplish tasks (e.g., detecting spam) within a particular context (e.g., email message). Typically, a data scientist will use a large amount of data (e.g., comprising normal and spam email messages), a large amount of computational resources (e.g., a network of server computers), and several hours or days of computing time to train a machine learning model. The trained model can then be used to accomplish its respective task, e.g., identify whether incoming email messages are normal or spam.

Sometimes, a particular task (e.g., spam detection) is applicable to multiple contexts. For example, machine learning models can be used to detect spam email messages or spam text messages. Typically, a data scientist develops separate models for each context, e.g., a first model used to detect spam email message and a second model used to detect spam text messages. This modelling strategy can be expensive with regards to time, data, and computational resources, as a different model needs to be trained for each context, and each model requires a large amount of data, a large amount of computational resources, and several hours to train.

Established contexts (e.g., those that have existed for several years) typically have large amounts of existing training data. For these contexts, it is possible to develop effective machine learning models that can be used for a particular task. For example, there is a large amount of available credit card transaction data that can be used for a task such as detecting fraudulent credit card transactions. However, there is not usually a large amount of available training data for new contexts. For example, “real-time payments,” payments that are initiated and settled within a short time period, are comparatively new, and little data is available. As such it is difficult to develop a machine learning model to, for example, detect fraudulent real-time payments.

Due to the development of new computer and Internet technologies, new contexts appear frequently, and as such, it can be difficult to train machine learning models to perform tasks corresponding to these new contexts. Thus there is a need for new methods for training machine learning models to overcome the problems described above.

Embodiments address these and other problems, individually and collectively.

### SUMMARY

Embodiments of the present disclosure relate to new machine learning models and training methods. These methods can be used to quickly train machine learning models to perform tasks, even for new contexts which don't have a large amount of available training data. In summary, embodiments can accomplish this by leveraging existing data for similar contexts and tasks, as well as using a novel “image representation” or “color map” representation of input data used to train a target machine learning model.

Throughout the disclosure, the term “source” will typically be used to refer to datasets, contexts, tasks, etc., which are “well-established” and for which there is a large amount of useful training data available. The term “target” will typically be used to refer to datasets, contexts, tasks, etc., for which there is little data available, which may be because a target context is new, i.e., corresponds to new technologies or practices (e.g., real-time payments). Conventionally, it can be difficult to train target machine learning models to perform tasks corresponding to these new target contexts, because little training data is available. Embodiments of the present disclosure provide novel training methods that can be used to overcome these difficulties.

In embodiments, in order to train a target model (used to, for example, detect fraudulent real-time payments), a computer system can use one or more source datasets to generate a plurality of source sub-sets. As an example, a computer system can divide a source data set comprising 10 million data elements into 10,000 sub-sets, each comprising, e.g., 1,000 data elements. Each sub-set of the plurality of sub-sets can be used to train a sub-model to perform a sub-task. For example, if the source data set comprises credit card transaction data, corresponding to normal credit card transactions and fraudulent credit card transactions, each sub-model can be trained to identify fraudulent credit card transactions within their corresponding sub-set.

After training the sub-models, the computer system can determine an estimate parameter set using the trained sub-models and their respective model parameters. Later, the estimate parameter set can be used to facilitate the training of the target machine learning model (e.g., the real-time payment fraud detection model). Under normal conditions, it may be difficult to train this target machine learning model, because it may correspond to a context and a task for which there is little available training data. However, by using this parametric estimation method, embodiments can leverage existing source data to train the target machine learning model, even when there is only a small amount of available target data.

In addition to achieving better performance in both precision (approximately 7% improvement) and recall (approximately 10% improvement) over conventional models such as deep neural networks, embodiments greatly reduce the amount of training data needed to train a target model (such as a convolutional neural network) to perform a new task. For a task which requires over 10 million data elements in order to train a conventional deep neural network, embodiments of the present disclosure may only need approximately 20,000 data elements. Likewise, embodiments of the present disclosure can be used to train target models for new tasks roughly 120 times faster than a conventional deep neural network.

Another aspect of embodiments of the present disclosure is the use of “color maps,” a novel configuration of (typically non-image) input data. Prior to training the sub-models or the target model, feature extraction can be performed on data from a source data set or a target data set, in order to produce source feature vectors and target feature vectors. These feature vectors can then be converted into color maps, which can be used to train the sub-models or target models. For example, a 1 by 192 feature vector can be converted into an 8 by 8 color map with 3 color channels (e.g., red, green, and blue). This conversion process can be used to capture relationships between elements in the data vector as spatial relationships between “pixels” in the color map. These spatial relationships can be more easily detected by sub-models or target models, resulting in improved model performance. In addition, these color maps enable the use of efficient machine learning models typically used for image processing, such as convolutional neural networks (CNNs).

One embodiment is directed to a method performed by a computer system for training a target model to classify a plurality of target data values as normal or anomalous. The computer system can generate a plurality of source sub-sets using one or more source data sets. The one or more source data sets can comprise a plurality of source data values. Each source sub-set can comprise a sub-set of source data values from the plurality of source data values. The source data values may be labeled. The computer system can train a plurality of sub-models corresponding to the plurality of source sub-sets to classify the plurality of source data values in the plurality of source sub-sets. In doing so, the computer system can produce a plurality of loss functions, which can relate a plurality of performance metrics to a plurality of sub-model parameter sets. Each performance metric of the plurality of performance metrics and each sub-model parameter set of the plurality of sub-model parameter sets can correspond to a sub-model of the plurality of sub-models. The computer system can use the plurality of loss functions to determine an estimate parameter set and train a target model using the target data set and the estimate parameter set, in doing so, generating a target parameter set corresponding to the target model. Training the target model can enable the target model to be used to classify the plurality of target data values as normal or anomalous.

Another embodiment is directed to a method performed by a computer system. The computer system can receive a data set comprising a plurality of data values, which can be labeled. The computer system can perform a feature extraction process on the plurality of data values, thereby producing a plurality of data vectors, each data vector comprising a plurality of feature values. For each data vector of the plurality of data vectors, the computer system can determine a width dimension, a height dimension, and a depth dimension based on a number of feature values in the plurality of feature values in the data vector. The computer system can also generate one or more value maps comprising a plurality of value cells, wherein the number of value maps in the one or more value maps is equal to the depth dimension. The width of each value maps of the one or more value maps can equal the width dimension, and the height of each value map of the one or more value maps is equal to the height dimension. The computer system can populate the one or more value maps using the plurality of feature vectors by assigning the plurality of feature values to the plurality of value cells. The computer system can generate, based on the one or more value maps, one or more color maps comprising a plurality of color cells, each color cell of the plurality of color cells associated with a color value corresponding to a feature value. Each color map can be associated with a particular color channel of one or more color channels. The computer system can generate a unified color map comprising the one or more color maps, thereby generating a plurality of unified color maps. The computer system can use the plurality of unified color maps and a plurality of labels corresponding to the plurality of data values to train a machine learning model.

These and other embodiments of the disclosure are described in detail below. For example, other embodiments are directed to systems, devices, and computer readable media associated with methods described herein.

### Terms

A “server computer” may refer to a powerful computer or cluster of computers. For example, a server computer can include a large mainframe, a minicomputer cluster, or a group of servers functioning as a unit. In one example, a server computer can include a database server coupled to a web server. A server computer may comprise one or more computational apparatuses and may use any of a variety of computing structures, arrangements, and compilations for servicing the requests from one or more client computers.

A “memory” may refer to any suitable device or devices that may store electronic data. A suitable memory may comprise a non-transitory computer readable medium that stores instructions that can be executed by a processor to implement a desired method. Examples of memories include one or more memory chips, disk drives, etc. Such memories may operate using any suitable electrical, optical, and/or magnetic mode of operation.

A “processor” may refer to any suitable data computation device or devices. A processor may comprise one or more microprocessors working together to accomplish a desired function. The processor may include a CPU that comprises at least one high-speed data processor adequate to execute program components for executing user and/or system generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xenon, and/or XScale; and/or the like processor(s).

A “data set” may refer to any collection of data values. For example, a data set may correspond to a set of emails, and can comprise statistics or other measurable characteristics of those emails (e.g., the time at which they were sent, their length, etc.). A “data sub-set” may refer to a sub-set of data values from the data set. Data values may be organized into “data vectors,” collections of data values that are typically related to the same thing or observation. For example, a data vector corresponding to a hospital patient may have an associated data vector comprising the elements {“name,” “age,” “gender,” “weight”}. A “feature” may comprise a data value that may be of particular relevance to a machine learning model. Likewise, a “feature vector” may comprise a collection of features. A “dummy value” or “dummy feature value” may comprise a value without any inherent meaning, which can be used to “pad” data, if for example, a machine learning process requires a certain amount of input data to function. A “velocity” may refer to a data value that is associated with a particular time period. “Number of emails received in the last 30 minutes” is an example of a velocity.

A “context” may refer to a particular situation, environment, or use case. “Email communications” or “traffic monitoring” are examples of contexts. A context may have an associated “task,” a particular action relevant to that context. For example, for the context of email communications, a task may comprise, e.g., “identifying spam emails.” As another example, for the context of “traffic monitoring,” a task may comprise, e.g., “predicting traffic congestion.” A task may be carried out using a machine learning model, trained using data from a data set. A “sub-task” may refer to a task that is part of a larger task. For example, if a task comprises “identify spam emails from among these 10 million email messages,” a sub-task may comprise “identify spam emails from among a sub-set of 1 million email messages.”

“Classification” may refer to a process by which something (such as a data value, feature vector, etc.) is associated with a particular class of things. For example, an image can be classified as being an image of a dog. “Anomaly detection” can refer to a classification process by which something is classified as being normal or an anomaly. An “anomaly” may refer to something that is unusual, infrequently observed, or undesirable. For example, in the context of email communications, a spam email may be considered an anomaly, while a non-spam email may be considered normal. Classification and anomaly detection can be carried out using a machine learning model.

A “machine learning model” may refer to a program, file, method, or process, used to perform some function on data, based on knowledge “learned” during a training phase. For example, a machine learning model can be used to classify feature vectors as normal or anomalous. In “supervised learning,” during a training phase, a machine learning model can learn correlations between features contained in feature vectors and associated labels. After training, the machine learning model can receive unlabeled feature vectors and generate the corresponding labels. For example, during training, a machine learning model can evaluate labeled images of dogs, then after training, the machine learning model can evaluate unlabeled images, in order to determine if those images are of dogs. A “sub-model” may refer to a machine learning model that is used for a “sub-task.”

Machine learning models may be defined by “parameter sets,” comprising “parameters,” which may refer to numerical or other measurable factors that define a system (e.g., the machine learning model) or the condition of its operation. In some cases, training a machine learning model may comprise identifying the parameter set that results in the best performance by the machine learning model. This can be accomplished using a “loss function,” which may refer to a function that relates a model parameter set to a “loss value” or “error value,” a metric that relates the performance of a machine learning model to its expected or desired performance.

A “map” or “value map” may comprise a multi-dimensional array of values. A map may organize “value cells” into rows and columns. A “color map” may comprise a multi-dimensional array of color values, and may represent or be interpreted as an image.

### BRIEF DESCRIPTION OF THE DRAWINGS

FIG. 1 shows a block diagram overviewing an anomaly detection framework according to some embodiments.

FIG. 2 show a flowchart of a method of generating a unified color map according to some embodiments

FIG. 3 shows a variety of exemplary data features according to some embodiments.

FIG. 4 shows a diagram of a unified color maps according to some embodiments.

FIG. 5 shows a diagram of a color map comprising rows and columns according to some embodiments.

FIG. 6 shows a comparison of a normal and an anomalous color map.

FIG. 7 shows a diagram summarizing a method for generating an estimate parameter set using metamodeling according to some embodiments.

FIG. 8 shows a flowchart of a method used to train a target model using metamodeling according to some embodiments.

FIG. 9 shows a graph of sub-model loss functions according to some embodiments.

FIG. 10 shows a parameter estimation graph and target model parameter estimation formula according to some embodiments.

FIG. 11 shows an exemplary computer system according to some embodiments.

### DETAILED DESCRIPTION

Prior to describing embodiments of the present disclosure in more detail, it may be useful to review some general concepts in machine learning and machine learning classifiers. A classifier typically refers to a machine learning model that produces classifications corresponding to input data. A binary classifier produces one of two classifications for an input, such as normal or anomalous (e.g., fraudulent).

Classifiers (and more generally, machine learning models) are often defined by sets of parameters, which generally control how the machine learning model classifies input data. As an example, a support vector machine (SVM) is a type of machine learning model that divides data points using a hyperplane. Data on one “side” of the hyperplane is classified as one class (e.g., normal) while data on the other side of the hyperplane is classified as another class (e.g., anomalous). The parameters of the support vector machine can comprise the coefficients used to define the hyperplane. Changing these parameters changes the shape of the hyperplane, and thus changes which data points the SVM classifies as normal or anomalous.

In broad terms, the process of training a machine learning model can involve determining the set of parameters that achieve the “best” performance, usually using a loss or error function. A loss function relates the expected or ideal performance of the machine learning model to its actual performance on a (typically labeled) training data set. The loss function typically decreases in value as the model's performance improves. As such, training a machine learning model often involves determining the set of parameters that minimize a loss function corresponding to that model. Sometimes a random parameter estimate is generated as an initial parameter “guess,” and then a process such as gradient descent is used to iteratively refine the parameter estimate, eventually resulting in a final set of parameters associated with the machine learning model.

Embodiments of the present disclosure involve new methods of generating an estimate parameter set, which enables meta-knowledge from existing source data sets to be used to train a target model to classify data from a target data set. A plurality of source models, each trained using data from a plurality of source sub-sets can each have an associated loss function. Rather than determining a set of parameters for each sub-model that minimize the loss function corresponding to that particular sub-model, a set of parameters can be determined that minimizes a collective loss function of the sub-models.

In rough terms, this set of parameters can be thought of as the set of parameters corresponding to the best performance of the “average” sub-model and sub-set. As such, it can be a good estimate parameter set used to classify data values in an unknown (but presumably similar) data set. For example, if real-time transactions are expected to be similar to credit card transactions, an estimate parameter set generated using a plurality of source sub-models that classify credit card transactions as normal or anomalous can be a reasonable estimate parameter set for training a target model to classify real-time transactions as normal or anomalous. Further, this parameter set estimation technique reduces the total amount of data required to train the target model, which can be useful when the target model corresponds to a new context without much available training data.

Having provided a brief review of machine learning, and particularly the concept of parameterization, it may be useful to describe embodiments of the present disclosure in more detail. Embodiments of the present disclosure are generally directed to systems and methods for using meta-modeling and “color mapping” to quickly and accurately train a target model to perform some form of anomaly detection task. Examples include detecting fraudulent credit card, ATM, or real-time transactions, or alternatively filtering spam emails, text messages, or phone calls. In many practical applications, a computer system may generate color maps, perform these training methods, implement target models, etc., according to embodiments of the present disclosure.

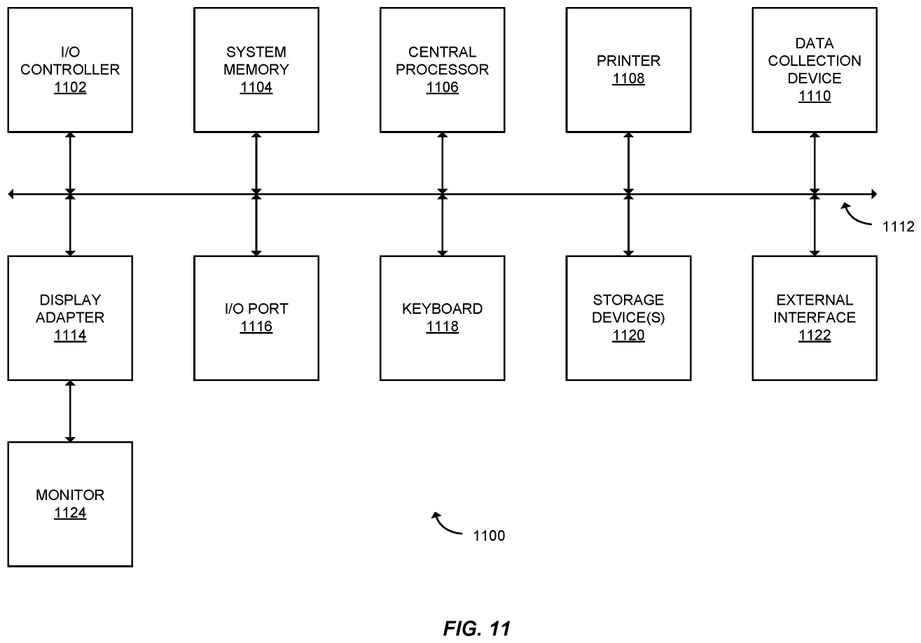

As such, for the sake of convenience and ease of description, many steps in this disclosure are described from the perspective of a computer system, or carried out by a computer system, even though they could conceivably be implemented via other means. Such a computer system could comprise a personal computer, a server computer, a cluster comprising multiple computers, a smartphone, a tablet, a computer mainframe, etc. A general computer system 1100 is described further below with reference to FIG. 11.

### A. Framework Overview

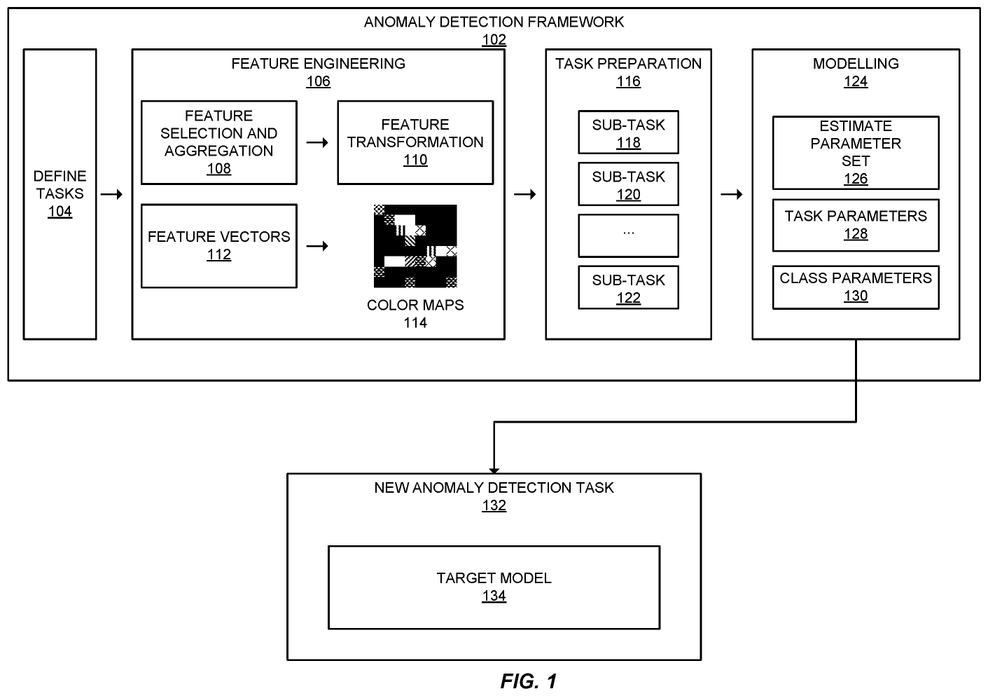

FIG. 1 shows an overview of an anomaly detection framework 102 according to some embodiments. Generally, the anomaly detection framework 102 can be used to perform meta-modeling using available source data. This meta-modelling can be used to train a target model 134 to perform a new anomaly detection task 132 on target data, which may not be as easy to acquire or as numerous as the source data. For example, the source data may correspond to technologies or practices that are established and relatively commonplace (e.g., data related to cars that use internal combustion engines, data related to credit card transactions etc.), while the target data may correspond to technologies or practices that are comparatively novel and not commonplace (e.g., data related to electric vehicles, data related to real-time transactions, etc.) Conventionally, it may be difficult to train the target model 134 because of the relative scarcity of the target data. However, using the anomaly detection framework 102, it may be possible to train the target model 134 even without a large amount of target data.

One step associated with the anomaly detection framework 102 is the definition of tasks 104. This step can involve determining what the overall goal of the machine learning model is, as well as defining what constitutes an anomaly. An anomaly may be define as, for example, an instance of a fraudulent credit card transaction or an instance of a spam email message. Task definition 104 may also involve determining how “strict” a machine learning model is when performing anomaly detection, for example, by defining what sort of threshold or anomaly score is required to identify a particular source or target data element as an anomaly.

Another step is feature engineering 106. During feature engineering, a computer system can extract features from one or more source data sets (and optionally one or more target data sets). Relevant features (e.g., features that are more strongly correlated with anomalous or normal classifications) can be selected and aggregated at step 108 and used to produce a plurality of feature vectors 112. In machine learning, a feature vector generally corresponds to a single data observation, and the features (i.e., elements) in the feature vector correspond to particular aspects of that observation. For example, a feature vector 112 could correspond to a particular credit card transaction, and a feature within that feature vector could comprise, e.g., a timestamp corresponding to the time at which that credit card transaction took place, or a country code associated with a country where that credit card transaction took place.

Embodiments of the present disclosure provide for a novel feature transformation method 110, which enables these feature vectors 112 to be transformed into color maps 114. Color maps 114 and this feature transformation process 110 are described in more detail below in Section C. In general terms, a color map 114 can be thought of as a small image that generally encodes the data in a corresponding feature vector 112. For example, a 1 by 192 feature vector 112 can be used to generate an 8 by 8 by 3 color map 114. A color map 114 can encode relationships between features in a feature vector 112 that are not captured by the feature vector itself, due to the two (or more) dimensional, spatial nature of the color map 114 (e.g., with the depth dimension being one). For example, two related features (e.g., number of credit card transactions within the last 30 minutes and credit card transactions within the last hour) can correspond to “pixels” located next to each other in the color map 114. The use of color maps 114 enables the use of machine learning systems commonly used for image processing, such as convolutional neural networks (CNN). Such systems can identify these spatial relationships between features. As such, the use of color maps 114 can improve anomaly detection accuracy.

Next, a task preparation step 116 can be performed. In this task preparation step 116, source data can be divided among a number of sub-tasks (e.g., sub-task 118, sub-task 120, sub-task 122). For example, if a task defined at step 104 is “train a machine learning system to identify fraudulent (anomalous) credit card transactions from among a dataset of 10 million credit card transactions in Mexico,” a sub-task could comprise “train a machine learning system to identify fraudulent credit card transactions from among a subset of 50,000 credit card transactions (pulled from the data set of 10 million) in Mexico.” Each sub-task can be assigned to a different source sub-model. Each of these sub-models can be trained in parallel, e.g., by a computer system comprising a computing cluster. Training the sub-models in parallel can reduce the overall amount of time required to train the sub-models, when compared to conventional methods in which a single (large) model may be trained by a single computer system or processor.

Training the source sub-models assigned to the sub-tasks 118-122 can involve determining sets of parameters corresponding to each sub-model. These sets of parameters can define how each sub-model performs anomaly detection, e.g., which color maps 114 in each of sub-set are identified as normal or anomalous. For each sub-model, a loss function can be determined that relates the performance of that sub-model to its corresponding set of sub-model parameters. When a sub-model performs well (i.e., it effectively classifies normal and anomalous color maps from among test data used during the training process) the loss function typically takes on a low value. When a sub-model performs poorly (i.e., it does not effectively classify normal and anomalous color maps from among test data used during the training process), the loss function typically takes on a high value.

As described above, loss functions themselves are a fairly conventional technique in machine learning. Many machine learning problems involve using an optimization technique (such as stochastic gradient descent) to determine a parameter set that minimizes the loss function, which is then used as the parameter set for the trained model.

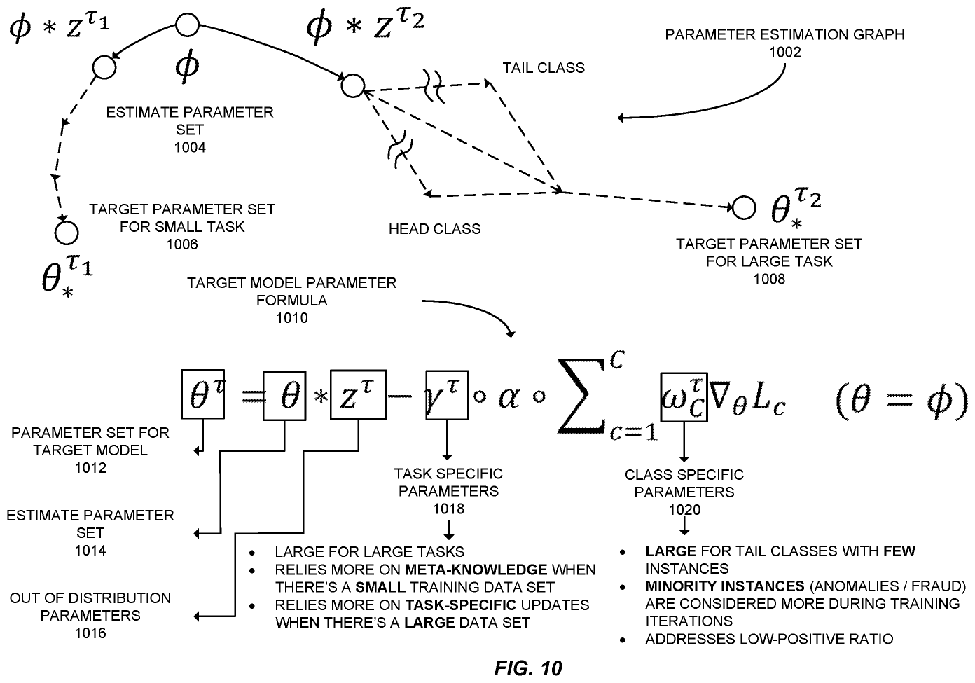

However, unlike conventional methods, embodiments of the present disclosure involve determining a parameter set that minimizes a cumulative loss associated with each of the source sub-tasks 118-122 and their corresponding sub-models. Provided that future training tasks are relatively “similar” to the sub-tasks 118-122, this “estimate parameter set” 126 can be used as a good estimate for these future training tasks (e.g., training the target model 134). This estimate parameter set 126 can be determined during a modelling step 124. Additionally, during the modeling step, task parameters 128 and class parameters 130 can be determined. These parameters are described in more detail below with reference to FIG. 10.

In general terms, these task parameters 128 and class parameters 130) enable the estimate parameter 126 to be better “tuned” to a new task (e.g., training the target model 134 to identify anomalies in a target data set) using a process known as “Bayesian Task Adaptive Meta-Learning” (See, for example: Lee, Hae Beom and Lee, Hayeon and Na, Donghyun and Kim, Saehoon and Park, Minseop and Yang, Eunho and Hwang, Sung Ju “Learning to Balance: Bayesian Metal-Learning for Imbalanced and Out-of-distribution Tasks” 2019 arXiv) Using these task parameters 128 and class parameters 130 can improve the precision and recall of the target model 134.

Afterwards, the anomaly detection framework 102 can be used to train a target model 134 (along with a target data set) to perform a new anomaly detection task 132. For example, the target model 134 could be used to detect fraudulent (anomalous) real-time transactions. In this way, data from a source domain (e.g., credit card transactions) can be leveraged, using meta-learning, to train the target model 134 to perform an anomaly detection task 132 associated with a target domain (e.g., real-time transactions). This meta-learning process reduces the amount of target data needed to train the target model 134, and reduces the training time necessary to train the target model 134. For example, over 10 million target feature vectors and 3 to 4 hours may be needed to train a conventional deep neural network to detect anomalies in the target feature vectors. By contrast, only 20,000 target feature vectors and 2 minutes are needed to train the target model 134, as a result of the anomaly detection framework 102.

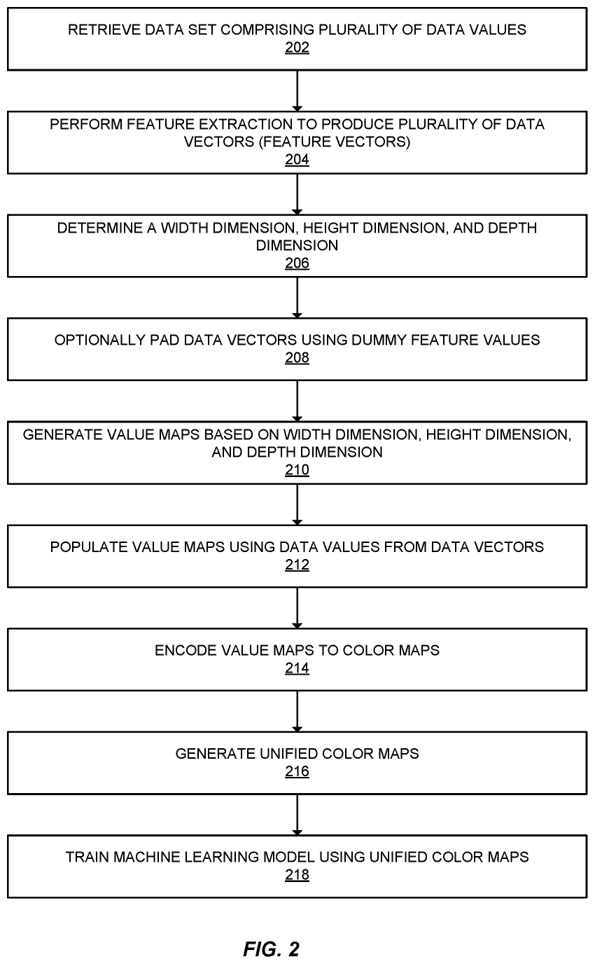

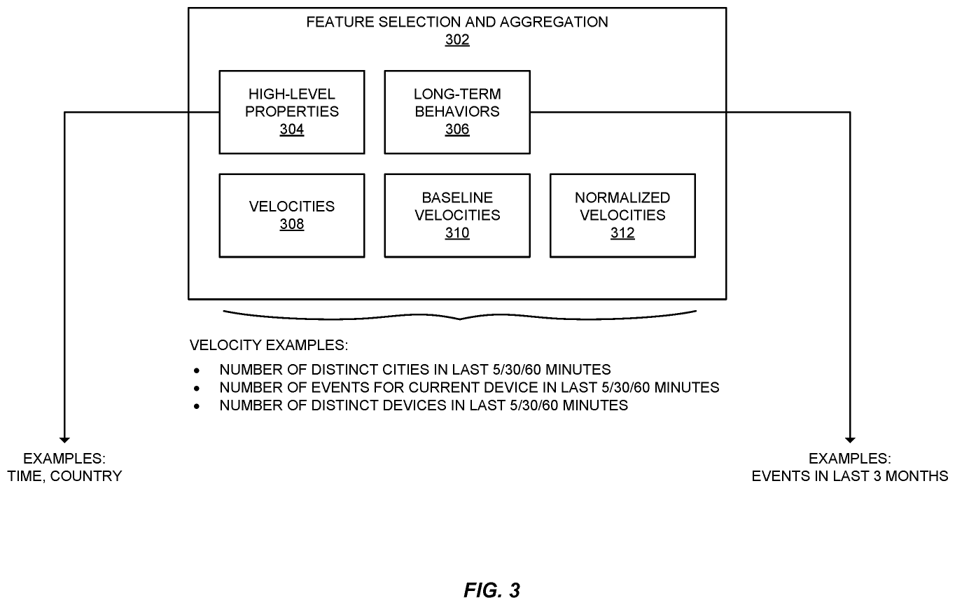

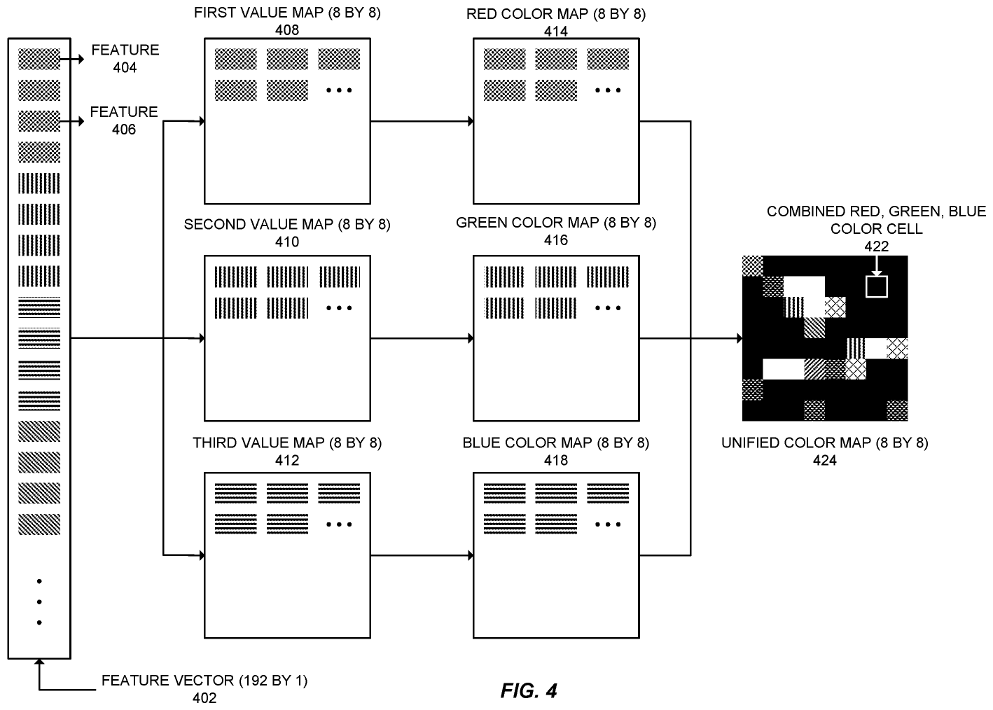

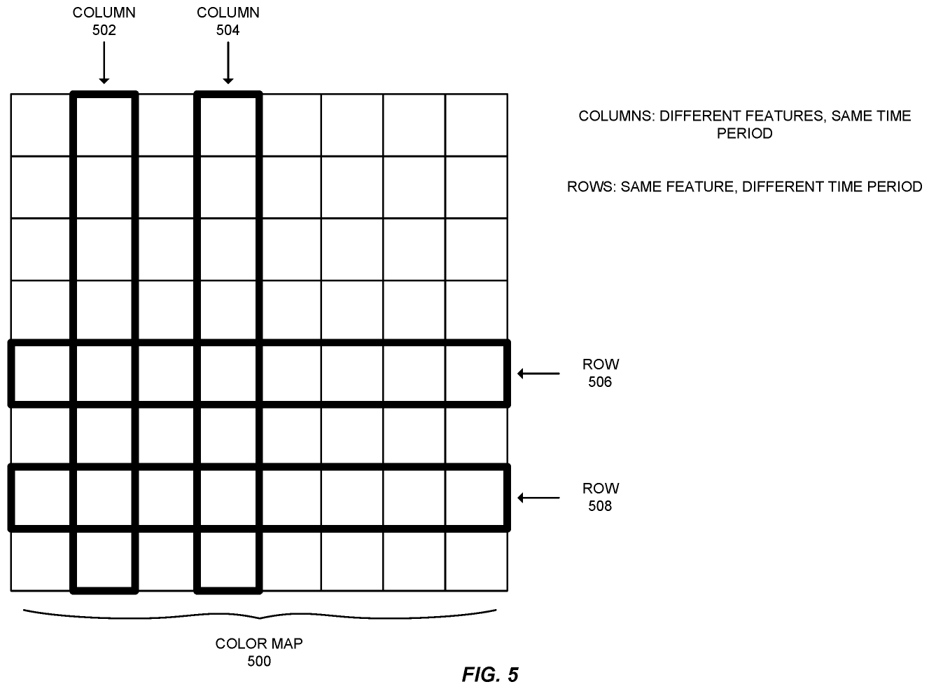

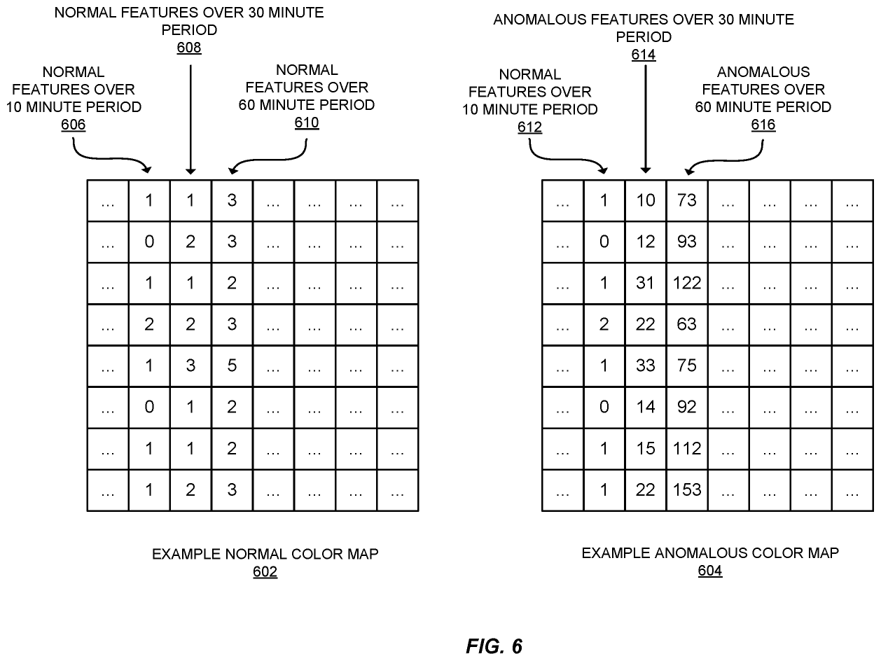

The feature engineering process 106, particularly feature extraction and the generation of color maps 114 is described in more detail below with reference to FIGS. 2-6. FIG. 2 shows a flowchart of a method used to extract features, generate color maps, and train a machine learning model using those color maps. FIG. 3 shows some features that may be useful, particularly for the exemplary application of detecting financial or transactional fraud. FIG. 4 shows an overview of a process used to generate a unified color map. FIG. 5 shows some exemplary spatial relationships between color cells within a color map. FIG. 6 shows examples of normal and anomalous color maps, particularly for the exemplary application of detection transactional fraud.

Referring now to FIG. 2, which shows a flowchart of a method corresponding to one aspect of embodiments of the present disclosure, namely, the generation and use of “color maps” to train a machine learning model. At step 202, a computer system can receive a data set comprising a plurality of data values. This plurality of data values may be labeled, and can be used to generate training and test data used to train a machine learning model. The computer system can receive the data set using any appropriate means, e.g., by retrieving the data set from a database locally stored on a hard drive, by receiving the data set from a server computer over the Internet, etc.

### B. Feature Extraction

At step 204, the computer system can perform a feature extraction process on the plurality of data values, thereby producing a plurality of data vectors. Each data vector can comprise a plurality of feature values. The computer system can identify feature values that may be of particular value to the context and task associated with the machine learning system. Any appropriate means can be used to define these feature vectors. For example, a data scientist can generate a list defining useful feature values from the data set.

For many data sets, there are typically a large number of potential features that can be selected and aggregated in order to generate feature vectors, which can be used to train a machine learning model. FIG. 3 shows some exemplary categories of features that may be useful for event-based anomaly detection (i.e., anomaly detection involving determining whether an event, such as a credit card transaction is normal or anomalous (e.g., fraudulent)). The selected features from FIG. 3 can be grouped into five broad categories: high-level properties 304, long term behaviors 306, velocities 308, baseline velocities 310, and normalized velocities 312.

High-level properties 304 can comprise, for example, properties of some event that are not velocities. For example, for features related to a credit card account or credit card transactions (or, e.g., ATM transactions), a high-level property could comprise the time at which a credit card transaction took place, a country where the credit card transaction took place, or a country of origin associated with a credit card account.

Long-term behaviors 306 can comprise, for example, features that correspond to long-term statistics of the data. For data relating to a credit card account, a long-term behavior can comprise, for example, a number of credit card transactions that took place over a three month period, or a number of unique devices that were used to perform credit card transactions over a three month period.

Velocities 308 can comprise features that correspond to events which take place over different time periods, particularly shorter time periods when compared to long-term behaviors. For example, if a long-term behavior corresponds to a number of events (e.g., credit card transactions) that took place over a three month period, velocities could correspond to a number of events that took place in the last 10 minutes, 30 minutes, hour, etc. Other examples of velocities include the number of distinct cities associated with events in the last 5/30/60 minutes (e.g., the number of cities in which credit card transactions associated with a particular account took place), a total number of events that took place over the last 5/30/60 minutes, and a number of distinct devices (e.g., smartphones, laptops, etc.) used to make credit card transactions (or e.g., real-time transactions) in the last 5/30/60 minutes.

Baseline velocities 310 can comprise features or statistics that comprise long-term measures of central tendency corresponding to the velocities 308. For example, if a velocity feature comprises “number of transactions over the last 30 minutes,” a baseline velocity can comprise “average number of transactions over 30 minute time periods over the last 3 months.” Normalized velocities 312 can comprise velocities 308 normalized using baseline velocities 310, e.g., a normalized velocity can comprise a velocity 308 divided by its corresponding baseline velocity 310.

### C. Generating Value Maps and Color Maps

After extracting the relevant features from the data set, the computer system can then perform a process in order to convert the data vectors into color maps, which can subsequently be used to train a machine learning model, such as a convolutional neural network. Referring back to FIG. 2, this process generally corresponds to steps 206-216.

At step 206, the computer system can determine, for each data vector of the plurality of data vectors, a width dimension, a height dimension and a depth dimension. The width dimension, height dimension, and the depth dimension can be based on a number of feature values in the plurality of feature values in the data vectors. The width dimension, height dimension, and depth dimension can later be used to generate a unified color map, such that the width, height, and depth (e.g., number of color channels) of the color map are equal to the width dimension, the height dimension, and depth dimension respectively.

In some embodiments, the product of the width dimension, the height dimension, and the depth dimension may be equal to the number of feature values in each feature vector, which can be one. For example, for a feature vector comprising 192 feature values, a width dimension of 4, a height dimension of 16, and a depth dimension of 3 could be generated, because 4*16*3=192. In some embodiments, the width dimension and height dimension may be equal, e.g., for a feature vector comprising 192 feature values, a width dimension of 8, a height dimension of 8, and a depth dimension of 3 could be selected. Determining an equal width dimension and height dimension can result in a “square” color map, which may be easier for some machine learning models to process. In some embodiments the width dimension may be at least two, the height dimension may be at least two, and the depth dimension may be at least one, such that the minimum resulting color map comprises at least a 2 by 2 mono-channel color map.

At step 208, the computer system can optionally pad the data vectors using dummy feature values after determining the width dimension, the height dimension and the depth dimension based on the number of feature values in the data vectors.

Conceivably, the number of relevant feature values may make it difficult to generate a multi-dimensional value map. For example, if there is a prime number of feature values, such as 191, it is not possible to factor the number of feature values in order to determine a width, height and depth. However, if there is just one additional feature value (192), it would be possible to factor 192 into 8, 8, and 3, enabling the generation of an 8 by 8 by 3 value map. As such, in some embodiments, the computer system can generate one or more dummy feature values and include the one or more dummy feature values in each data vector, in order to facilitate the generation of value maps. These dummy feature values can comprise zero or NULL values.

Even if the length of each data vector is not prime, it may still be advantageous to pad the data vectors using dummy feature values, e.g., in order to produce square value maps. For example, a data vector comprising 42 feature values can be used to produce a 2 by 7 by 3 value map, but if 6 dummy feature values are added, a 4 by 4 by 3 value map can be produced. This may be advantageous because some image based machine learning models, such as convolutional neural networks may function more effectively when evaluating square images rather than narrow rectangular images.

After determining the width dimension, height dimension, and depth dimension, the computer system can then use the data in each data vector to generate a corresponding color map. This process generally corresponds to steps 210-216 in FIG. 2, and is summarized in FIG. 4. FIG. 4 generally shows a process used to generate an exemplary unified color map 424 from an exemplary feature vector 402. The feature vector 402 can comprise a 192 by 1 array of features, each represented by patterned rectangles. This feature vector can correspond to a particular data record or observation. For example, feature vector 402 can correspond to a particular credit card transaction. In such a case, feature 404 could correspond to, for example, an amount associated with the credit card transaction, and feature 406 could correspond to a time stamp associated with the credit card transaction

The features in this feature vector can be used to populate value maps, two dimensional arrays of value cells. In FIG. 4, three value maps are shown: a first value map 408, a second value map 410, and a third value map 412. Each value map comprises an 8 by 8 array of values. Similar features (indicated by similar patterned rectangles) can be grouped within similar value maps. The values in each value map can be encoded in order to produce color maps corresponding to the value maps. FIG. 4 shows three color maps: a red color map 414, a green color map 416, and a blue color map 418. Each color map can correspond to a particular color channel (e.g., red, green, and blue color channels) and can comprise color cells. These three color maps 414-418 can be combined to produce a unified color map 424, comprising a plurality of combined red, green blue color cells 422. This unified color map can be interpreted as an image by the computer system.

As described above, each color map may correspond to a particular color channel. These color maps can be combined to produce a unified color map, which can, generally be interpreted and viewed like an image. Embodiments of the present disclosure can be practiced using any appropriate color model, which may be selected in part due to the depth dimension determined at step 206 of the flowchart of FIG. 2. For example, for a depth dimension of three, the one or more color channels can comprise a red color channel, a green color channel and a blue color channel. If the depth dimension is four, the one or more color channels could additionally comprise an alpha channel. Alternatively, if the depth dimension was four, the one or more color channels could comprise a cyan color channel, a magenta color channel, a yellow color channel, and a black color channel (e.g., corresponding to the CMYK color model). If the depth dimension was five, the one or more color channels could comprise the CMYK color channels and additionally comprise an alpha channel.

Returning to FIG. 2, at step 210, for each data vector, the computer system can generate one or more value maps comprising a plurality of value cells. Each value map can comprise a two dimensional array of value cells, where the width of each value map is equal to the width dimension and the height of each value map is equal to the height dimension. The number of value maps corresponding to each data vector can correspond to the depth dimension. For example, for a width dimension of 8, a height dimension of 8, and a depth dimension of 8, for each data vector, three 8 by 8 value maps can be generated.

After the value maps are generated, the computer system can, for each data vector, populate the corresponding one or more value maps using the plurality of feature vectors. The computer system can do this by assigning each feature vector of the plurality of feature vectors to a corresponding value cell in the corresponding value map. The corresponding value map of the one or more value maps may be determined in order to associate the feature value with similar feature values within the corresponding value map. The computer system may also determine a row of a plurality of rows in the corresponding value map. The row may be determined in order to associate the feature value with similar feature values within the row. Further, the computer system may determine a column of a plurality of columns in the corresponding value map. The column may be determined based on a temporal characteristic of the feature value (e.g., a time period corresponding to the feature value, such as 30 minutes, one hour, etc.). The computer system can then assign the feature value to the corresponding value cell defined by the row and the column.

The computer system can populate the value maps using an organizational scheme which may be defined by an operator of the computer system in advance. An organizational scheme may generally involve determining, for a given feature value, which value map to put that feature value into, and where to place that feature value within that value map (e.g., at a particular row and column). The broad goal of an organizational scheme can be to place similar feature values within the same feature map in such a way to generate a spatial pattern or ordering that can be detected by a machine learning model. For example, assuming that a machine learning model is being trained to detect spam email messages, each feature value could correspond to some aspect or measurement of an email message. Some feature values could correspond to content information, e.g., the subject, the body of the message, what words appear in the message, the frequency of each word, the sender, etc. These feature values can be grouped within the same value map. Other feature vectors can correspond to more technical information about the email message, such as STMP or TCP header information, the network path taken by the message from the sender to the receiver, etc. This feature values can be grouped within a second value map, distinct from the previously mentioned value map.

In some embodiments, the feature vectors may correspond to events, such as e.g., credit card transactions, which take place over corresponding time periods (e.g., 5 minutes, 30 minutes, an hour, etc.). The computer system can populate the value maps based on temporal characteristics of the feature values, such that each feature value is placed in the value maps near other feature values based on shared or similar temporal characteristics. For example, the temporal characteristic can comprise a corresponding time period, and feature values can be placed in the value map such that each column (of a plurality of columns) in the value map corresponds to the same time period.

FIG. 5 illustrates one potential organization method for values in a color map 500. As described above, organizing related data spatially in a color map can improve classification accuracy, because machine learning models trained on this data (such as convolutional neural networks) can learn to identify spatial patterns in the data. A color map 500, corresponding to a particular color channel (e.g., a red color channel) can be organized into rows and columns, including columns 502 and 504 and rows 506 and 508.

In one particular organization scheme, each row can correspond to a different type of velocity feature, and each column can correspond to a different time period corresponding to that velocity feature. As such, in the exemplary color map 500 of FIG. 5, the eight color values in column 502 can correspond to eight different velocities over one time period (e.g., minutes), while the eight color values in column 504 can correspond to those eight velocities over another time period (e.g., 30 minutes). The eight color values in row 506 can correspond to a single velocity feature over eight different time periods, while the eight color values in row 508 can correspond to a different velocity feature vector over the same eight time periods. However, it should be understood that this organization scheme is provided only for the purpose of example, and that other organization schemes are also valid, e.g., each row could correspond to a different time period and each column could correspond to a different type of velocity feature.

As an example, assuming that the color map generally corresponds to online credit card transaction data corresponding to a particular account. Row 506 then could correspond to features such as the number of unique devices (e.g., laptops, smartphones, etc.) used to perform credit card transactions for that account over eight different time periods. Each distinct column in that row can correspond to a different time period. Continuing the example, the color cell located in column 502 row 506 could correspond to the number of unique devices used to make an online credit card transaction (corresponding to that account) over a 10 minute period, while the color cell located in column 504 row 506 could correspond to the number of unique devices used to make an online credit card transaction (corresponding to that account) over a 30 minute period.

### 1. Encoding Value Map to Color Map and Training

Returning to FIG. 2, at step 214, the computer system can generate, for each data vector, based on the one or more value maps, one or more color maps comprising a plurality of color cells. Each color cell of the plurality of color cells can be associated with a color value corresponding to a feature value, and each color map can be associated with a particular color channel (e.g., red, green, and blue, or cyan, magenta, yellow, and black). In some embodiments, particularly if a higher fidelity color map or image format is being used, the values in the value maps can be directly transferred to their respective color cells in the generated color maps. In other embodiments, if lower fidelity color maps or image formats are being used, each value in the value maps may need to be encoded or compressed prior to generating the corresponding color maps.

At step 216, for each data vector, the computer system can generate a corresponding unified color map. This unified color map can comprise the one or more color maps, e.g., the unified color map can comprise a single image file generated using each of the corresponding color maps. As this step is performed for each data vector, the computer system can thereby generate a plurality of unified color maps.

Afterwards, at step 218, the computer system can train a machine learning model (such as a convolutional neural network) using the plurality of unified color maps. The computer system can additional use a plurality of labels corresponding to the plurality of data values, which can, for example, label the data values (and their corresponding color maps) as corresponding to normal or anomalous data. The machine learning model can thus learn to identify normal or anomalous data by evaluating the color maps.

### 2. Example Normal and Anomalous Color Map

FIG. 6 shows an example of a normal color map 602 and an anomalous color map 604. Rather than representing the color cells using colors, the value associated with each color cell is represented numerically for ease of exposition. As described above, feature values, or their corresponding encodings can be organized by columns, such that each cell in each column corresponds to the same time period. In the normal color map 602, the second column 606 corresponds to (normal) features over a 10 minute time period, the third column 608 corresponds to features over a 30 minute time period, and the fourth column 610 corresponds to features over a 60 minute time period. Likewise, in the anomalous color map 604, the second column 612 corresponds to (normal) features over a 10 minute time period, the third column 614 corresponds to (anomalous) features over a 30 minute period, and the fourth column 616 corresponds to anomalous features over a 60 minute period.

The columns 606-616 in FIG. 6 could correspond to features corresponding to credit card transactions. For example, column 606 could correspond to the number of credit card purchases made using a particular credit card in the last 10 minutes, while column 610 could correspond to the number of credit card purchases made using the same credit card in the last 60 minutes.

FIG. 6 illustrates a pattern in these three columns, which can be identified and interpreted by a machine learning model, such as a convolutional neural network (CNN), in a way that may be difficult for a machine learning model to identify if the input data is represented as a one dimensional feature vector, due to the spatial orientation of the two-dimensional color channel.

Because the time period (10, 30, 60 minutes) increases from left to right, it is expected that the corresponding values, represented by the color cells should also increase, in a manner consistent with the time period. For example, because column 610 corresponds to a time period six times as long as column 606, it is a reasonable estimate that the number of transactions during that time period will be somewhere around six times the number of transactions corresponding to column 606. However, in the anomalous color map 604, the feature values in column 616 are roughly 30 to 150 times greater than the values in column 612, indicating anomalous use of a credit card.

Machine learning models typically used for image processing, such as CNNs can correlate these horizontal progression patterns with normal and anomalous data labels, in order to learn the relationship between the two. In a comparable one dimensional feature vector, such horizontal progression patterns do not exist, and cannot be correlated by a machine learning model. As such, the use of color maps can lead to improvements to classification accuracy, precision, and recall over conventional one dimensional feature vectors.

### D. Meta-Modelling

As described above, another aspect of embodiments of the present disclosure is a meta-modeling method. This meta-modelling method can be used to leverage readily available source data to train a target model to perform anomaly classification on target data, even when only a small amount of target data is available. This is an advantage over conventional machine learning methods, which typically cannot meaningfully train a model without much available training data.

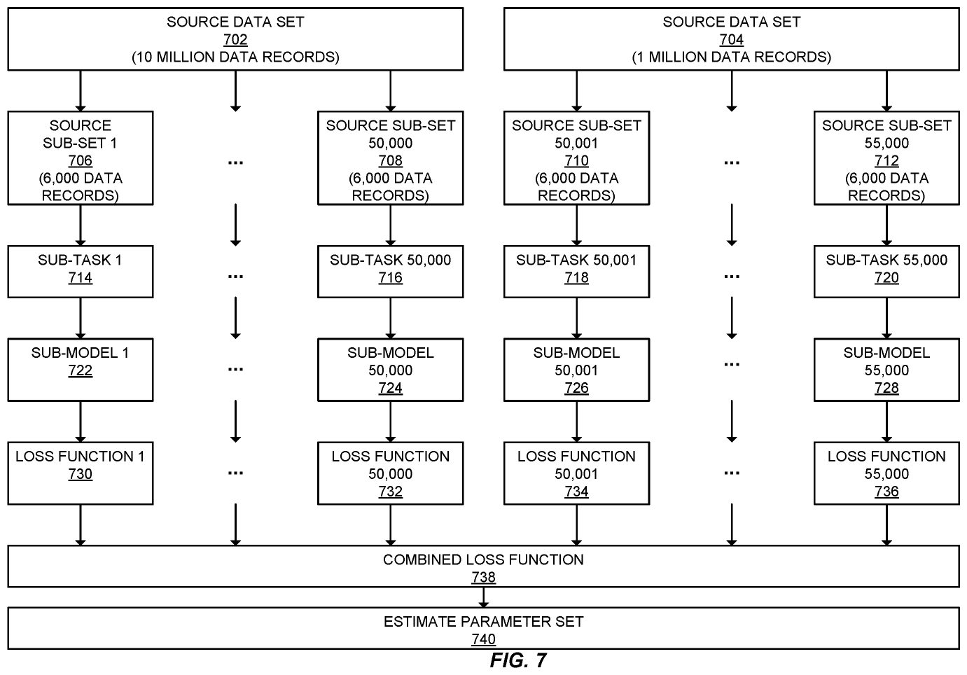

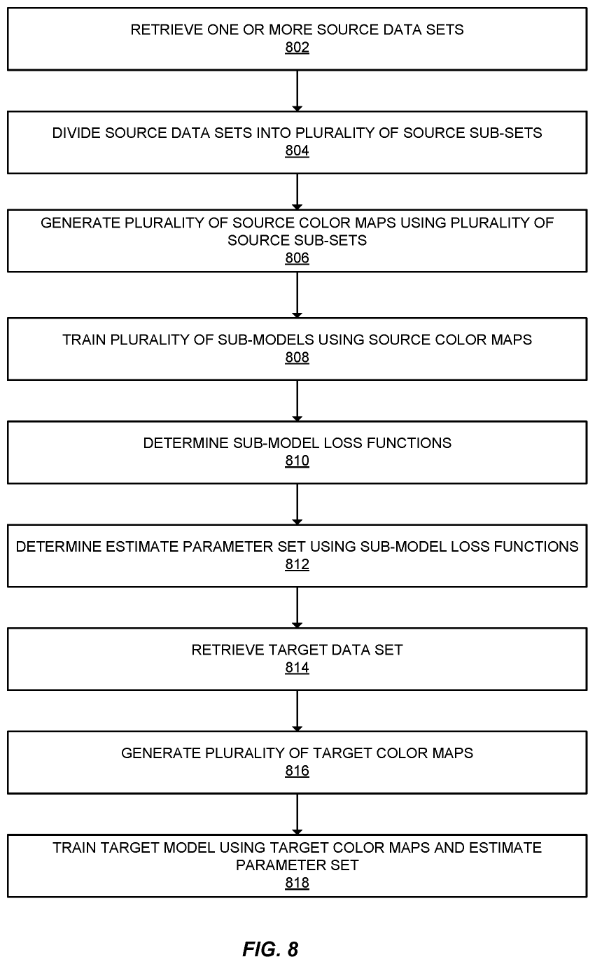

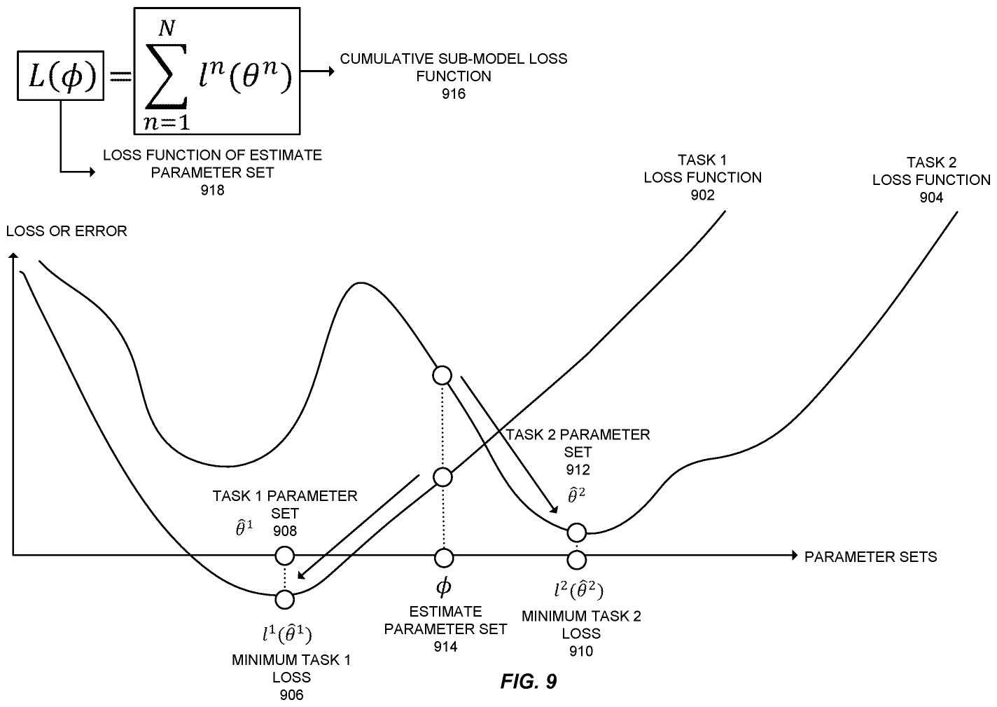

FIG. 7 shows a diagram summarizing some meta-modeling methods according to embodiments, which are described in more detail with reference to the flowchart of FIG. 8, as well as FIGS. 9 and 10.

A computer system can acquire or otherwise retrieve any number of applicable source data sets, such as source data set 702 and source data set 704. These source data sets can correspond to similar or different contexts, which may be relevant to some target context. For example, if an eventual goal of the computer system or its operator is to train a target model to identify fraudulent real-time transactions, source data set 702 could correspond to, e.g., credit card transactions, and source data set 704 could correspond to e.g., ATM transactions, check transactions, etc. In the example of FIG. 7, source data set 702 comprises 10 million data records, while source data set 704 comprises 1 million data records.

Once the source data sets 702-704 have been retrieved, the source data sets 702-704 can be divided into sub-sets. Source data set 702, for example, can be divided into 50,000 source subsets, e.g., source sub-set 1 706 to source sub-set 50,000 708. Source data set 704, for example, can be divided into 5,000 sub-sets, e.g., source sub-set 50,001 710 to source sub-set 55,000 712. In the example of FIG. 7, each subset can comprise 6,000 data records. In each sub-set, 5,000 data records can be used as training data and 1,000 data records can be used as test data. There can be overlap between data records in the source subsets, for example, some data records from source sub-set 1 706 may also be present in source sub-set 50,000 708.

The numbers presented in the preceding paragraph are intended only for the purpose of example, and are not intended to be limiting. There can be more or less source sub-sets that have a greater or lesser number of source data records. In some embodiments, it may be preferable (as illustrated in FIG. 7), for the source sub-sets to have two to three orders of magnitude less data records than the source set from which they were derived, in order to reduce total computing time. If the computer system has access to a large number of processing cores, it may be preferable to have a large amount of smaller sub-sets to take advantage of the parallel processing power. If the computer system has access to a smaller number of processing cores, it may be preferable to have a smaller amount of larger sub-sets.

After the source data sets 702-704 are split into source sub-sets 706-712, a sub-task can be defined for each source data set. These sub-task can comprise training a sub-model to identify anomalous data values within the respective source sub-set. A plurality of source sub-models 722-728 can be trained using their respective source sub-sets 706-712 to accomplish their respective sub-task 714-720. As an example, 5,000 data records from each source sub-set can be used to train each corresponding sub-model 722-728, and the remaining 1,000 data records can be used to test each source sub-model 722-728.

Each sub-model 722-728 can have a corresponding sub-model parameter set. For each sub-model 722-728, a loss function 730-736 can be determined that relates the sub-model parameter set to the performance of the sub-model 722-728, based on the sub-model's ability to evaluate the training data records in its respective source sub-set. The loss functions 730-736 can be combined to produce a combined (or cumulative) loss function 738.

An optimization process can be used to determine an estimate parameter set 740 by minimizing the combined loss function 738.

As described in more detail with reference to FIG. 10, the estimate parameter set 740 can be used as a “starting point” to train a target model to perform a task related to a context for which there is not much available training data. Conventionally it may be difficult or impossible to train a machine learning model without much training data. However, assuming that the source data sets 702-704 exhibit anomalous data characteristics that are similar (or expected to be similar) to the target data set, the “meta-knowledge” acquired from the estimate parameter set can enable the target model to be trained, even with little available target training data.

### 1. Source Data Retrieval and Feature Extraction

Referring now to FIG. 8, which shows a flowchart of a meta-modeling method according to some embodiments. At step 802, a computer system can retrieve one or more source data sets. The computer system can retrieve these one or more source data sets using any appropriate means, e.g., by retrieving them from a database, a hard-drive, via an Internet download, etc. The one or more source data sets may correspond to different or similar contexts, and may correspond to a plurality of source events. These source events could comprise, for example, a plurality of source credit card transactions, a plurality of source ATM transactions, a plurality of source real-time transactions, etc.

The one or more source data sets can comprise a plurality of source data values, which can correspond to a plurality of normal source events (e.g., legitimate credit card transactions) and a plurality of anomalous source events (e.g., fraudulent credit card transactions). In this case, the source data values can comprise source event data. A normal source event can comprise a source event at which no fraud took place, and an anomalous source event can comprise a source event at which fraud took place. These source data values can be labeled.

At step 804, the computer system can generate a plurality of source sub-sets using the one or more source data sets, e.g., as described in FIG. 7. Each source sub-set can comprise a sub-set of source data values from the plurality of source data values. The computer system can generate this plurality of source sub-sets using any appropriate means, such as random sampling source data values from the one or more source data sets without replacement.

### 2. Color Maps

These source sub-sets can be used to train a plurality of sub-models as part of the meta-modeling method described herein. However, prior to training the plurality of sub-models, the computer system can extract source feature vectors from the plurality of source sub-sets and generate source color maps, using the methods described above with reference to FIG. 2. These color maps, rather than source feature vectors themselves, can be used to train the plurality of sub-models.

At step 806, as part of generating a plurality of source unified color maps, the computer system can perform a feature extraction process on each source data vector of the plurality of source data values, thereby producing a plurality of source feature vectors. Each source feature vector can comprise a plurality of source feature values. The computer system can then generate a plurality of source unified color maps using the plurality of source feature vectors, such that each source unified color map of the plurality of source unified color maps corresponds to a source feature vector of the plurality of source feature vectors.

The computer system can generate the plurality of source unified color maps by (as described above with reference to FIG. 2) determining a width dimension, a height dimension, and a depth dimension based on a number of feature values in the source feature vectors. The computer system can then generate one or more value maps comprising a plurality of values cells. The number of value maps in the one or more value maps can be equal to the depth dimension, the width of each value map of the one or more value maps can be equal to the width dimension, and the height of each value map can be equal to the height dimension. Next, the computer system can populate the one or more value maps using the plurality of source feature vectors.

The computer system can generate, for each set of one or more value maps, one or more color maps comprising a plurality of color cells, each color cell of the plurality of color cells associated with a color value corresponding to a feature value. Each color map can be associated with a particular color channel. The computer system can then generate a source unified color map comprising the one or more color maps, thereby generating a plurality of source unified color maps.

### 3. Sub-Model Training

At step 808, the computer system can train a plurality of sub-models corresponding to the plurality of source sub-sets to classify the plurality of source data values in the plurality of source sub-sets (e.g., as normal or anomalous). Optionally, the computer system can divide the plurality of sub-models among a plurality of processors, then train the plurality of sub-models in parallel using the plurality of processors.

In doing so, at step 810, the computer system can determine a plurality of loss functions, which can relate a plurality of performance metrics to a plurality of sub-model parameter sets. Each performance metric of the plurality of performance metrics and each sub-model parameter set of the plurality of sub-model parameter sets can correspond to a sub-model of the plurality of sub-models.

the plurality of performance metrics can comprise a plurality of loss metrics or error metrics, which can measure the performance of a corresponding sub-model based on a difference between a plurality of source labels and a plurality of classifications produced by the plurality of sub-models. Each label of the plurality of labels and each classification of the plurality of classifications can correspond to a source sub-set and a source sub-model.

The plurality of sub-models may also be referred to as a plurality of “sub-task models.” Each sub-task model of the plurality of sub-task models can be associated with a sub-task of a plurality of sub-tasks. Each sub-task of the plurality of sub-tasks can comprise classifying source data values of a corresponding source sub-set as normal or anomalous.

The plurality of sub-models corresponding to the plurality of source sub-sets can be trained using a plurality of source unified color maps and a plurality of source labels. Each source unified color map of the plurality of source unified color maps and each source label of the plurality of source labels can correspond to a source data value of the plurality of source data values in the plurality of source sub-sets.

### a) Loss Functions

At step 812, the computer system can determine, based on the plurality of loss functions, an estimate parameter set. The process of using a plurality of loss functions to determine an estimate parameter set is illustrated by FIG. 9, which shows a graph of a loss function 902 associated with a first sub-task model (or just “sub-model”) and a graph of a loss function 904 associated with a second sub-task model. These loss functions relate the performance of each sub-model to their respective model parameters. As described above with reference to FIG. 7, typically there can be a comparatively large number of sub-tasks, sub-models, sub-model parameters, etc. (e.g., more than two of each, as depicted in FIG. 9). The small number of loss functions in FIG. 9 is intended to provide an easier or more accessible example of methods that can be used to determine an estimate parameter set 914. These methods can be extrapolated or otherwise generalized in order to generate an estimate parameter set 914 based on any number of loss functions.

In FIG. 9, sub-task parameter set 908 corresponds to minimum sub-task loss 906, while task parameter set 912 corresponds to minimum sub-task loss 910. However, while each of these parameter sets 908 and 912 correspond to the best performance of their corresponding sub-model, neither of these parameter sets correspond to the minimum cumulative sub model loss, i.e., the best cumulative performance for all sub-models. This minimum cumulative sub-model loss, represented by minimum cumulative sub-model loss function 916, can be used as the loss function for the estimate parameter set 918. Then, by performing an optimization process (such as stochastic gradient descent), a computer system can determine the estimate parameter set 914 (represented by @) that minimizes the cumulative sub-model loss function 916.

Conceptually, while the estimate parameter set 914 is likely not equal to any individual sub-task parameter set (e.g., task parameter sets 908 and 912), it is very likely to be more similar to any given sub-task parameter set than e.g., a random sub-task parameter set. As such, in “parameter space,” the distance between the estimate parameter set 914 and any given sub-task parameter set is expected to be comparatively small. Therefore, the estimate parameter set 914 is expected to be a good estimate or “starting point” for an optimization process used to determine a sub-model parameter set associated with a minimum corresponding task loss function. It is then expected that such an optimization process can quickly converge on the optimal sub-model parameter set due to the (expected) close proximity between the estimate parameter set 914 and the optimal sub-model parameter set. Assuming then, that a target task and a target data set are reasonably similar to any of the sub-tasks and sub-sets, then presumably the estimate parameter set 914 is also an effective “starting point” for an optimization process used to train a target model. For a source data set comprising credit card transaction data, and a target data set comprising real-time transaction data, it is reasonable to assume that these two data sets will be somewhat similar, as they both relate to transaction data. As such, it is reasonable to assume that an estimate parameter set 914, generated using sub-task loss functions corresponding to normal and anomalous source credit card transaction data, can be used to train a target model to identify normal or anomalous real-time transaction data.

### 4. Target Color Maps

After determining the estimate parameter set, the computer system can then train a target model using the estimate parameter set. Returning to FIG. 8, this process generally corresponds to steps 814-818. At step 814, the computer system can retrieve a target data set, e.g., in manner similar to retrieving the one or more source data sets at step 802, or retrieving a data set, as described in step 202 of FIG. 2. The target data set can be used to generate a plurality of target feature vectors, each target feature vector comprising a plurality of target feature values. The target data set may comprise target event data corresponding to a plurality of target events. These target events can comprise, for example, a plurality of target credit card transactions or a plurality of target real-time transactions. The computer system can perform a feature extraction process on each target data value of the plurality of target data values, thereby producing a plurality of target feature vectors.

At step 816, the computer system can generate a plurality of target unified color maps, using any of the techniques described above, e.g., with reference to FIG. 2 or step 806 of FIG. 8. The computer system can generate the plurality of target unified color maps using the plurality of target feature vectors, such that each target unified color map of the plurality of target unified color maps corresponds to a target feature vector of the plurality of target feature vectors. The computer system can determine a width dimension, a height dimension, and a depth dimension based on a number of feature values in each target feature vector. The computer system can generate one or more value maps comprising a plurality of value cells. The number of value maps in the one or more value maps can be equal to the depth dimension, the width of each value map can be equal to the width dimension, and a height of each value map of the one or more value maps can be equal to the height dimension.

The computer system can populate the one or more value maps using the plurality of target feature values. Afterwards, the computer system can generate, based on the one or more value maps, one or more color maps comprising a plurality of color cells, each color cell of the plurality of color cells associated with a color value corresponding to a target feature value. Each color map can be associated with a particular color channel (e.g., RGB color channels, CMYK color channels, etc.). The computer system can then generate a target unified color map comprising the one or more color maps, thereby generating a plurality of target unified color maps corresponding to the plurality of feature vectors.

### 5. Target Model Training

At step 818 the computer system can train a target model using a target data set (comprising, e.g., the plurality of target unified color maps), thereby generating a target parameter set corresponding to the target model. Training the target model can enable the target model to be used to classify a plurality of target data values as normal or anomalous. For example, the target data values could comprise data related to real-time transactions, and the trained target model can be used to classify those data values as corresponding to normal real-time transactions or anomalous (fraudulent) real-time transactions.

The target model can be trained using a Bayesian meta-learning process, which are described in more detail with reference to FIG. 10 below. Generally, the Bayesian meta-learning process can comprise the computer system determining class specific parameters, including a normal class weight and an anomalous class weight using, for example, a Softmax function. Additionally, the computer system can determine a plurality of task learning weights. A relative value of each task learning rate of the plurality of task learning rates can be proportional to a size of the target data set. These task learning rates may comprise “task specific parameters,” described below with reference to FIG. 10. Further, the computer system can determine a task distribution modifier, also referred to as “out-of-distribution parameters.” The computer system can then generate the target parameter set using the normal data class weight, the anomalous data class weight, the plurality of task learning weights, the task distribution modifier and the target (training) data set.

As described above, the target model can be trained using a plurality of target unified color maps (generated at step 816) and a plurality of target labels. Each target unified color map of the plurality of target unified color maps and each target label of the plurality of target labels can correspond to a target data value of the target data set. In some embodiments, the plurality of target data values can comprise a plurality of target event data values corresponding to a plurality of target events. These target events can comprise, e.g., events such as receiving an email message (which may be legitimate or spam) or performing a credit card transaction (which may be normal or fraudulent). A normal target event may comprise a target event at which no fraud took place, while an anomalous target event can comprise a target event where fraud took place. In some embodiments, the target mode can be referred to as a “target task model.” The target task model can be associated with a target task, such as classifying a plurality of target data values as normal or anomalous.

### a) Bayesian Task-Adaptive Meta-Learning

FIG. 10 shows a parameter estimation graph 1002 and a target model parameter formula 1010. The parameter estimation graph 1002 and target model parameter formula 1010 correspond to techniques known as “Bayesian task adaptive meta learning” (or Bayesian TAML) and were adapted from Lee, Hae Beom and Lee, Hayeon and Na, Donghyun and Kim, Saehoon and Park, Minseop and Yang, Eunho and Hwang, Sung Ju “Learning to Balance: Bayesian Metal-Learning for Imbalanced and Out-of-distribution Tasks” 2019 arXiv. Bayesian TAML is described in more detail in the above reference.

Embodiments of the present disclosure can use Bayesian TAML to further refine an estimate parameter set 1014 in order to train a target model, thereby generating a target parameter set corresponding to the target model 1012. In broad terms, the idea is that different target data sets may have different characteristics, which may make the estimate parameter set 1014 more or less applicable for training a corresponding target model. Bayesian TAML introduces additional parameters that can be used to modify the estimate parameter set 1014 to better fit the target data. These parameters include out-of-distribution parameters 1016, task specific parameters 1018, and class specific parameters 1020. This idea is illustrated visually in the parameter estimation graph 1002. Starting an estimate parameter set 1004 can be modified using these parameters to produce target parameter sets. For a small task (represented by τ₁) and a large task (represented by τ₁), the resulting parameter sets 1006 and 1008 diverge due to the differences between the two tasks.

The out-of-distribution parameters 1016, task specific parameters 1018, and class specific parameters 1020 are described in more detail in the above mentioned reference. Generally, the out-of-distribution parameters 1016 are used to modify the estimate parameter set 1014 based on the difference between the distribution of the source data set and the target data set. Assume for example, the source data set corresponds to credit card transaction data, and the target data set corresponds to real-time transaction data. If there are proportionally more instances of fraud in the source data set, the distributions of the source data set and target data set are different. The out-of-distribution parameters can correct this difference.

Generally, the task specific parameters 1018 address other differences between the source data set and the target data set, including differences in size between the two data sets. Broadly, the larger the target training data set, the less meta-modeling is necessary in order to train an accurate target model. As such, the task specific parameters 1018 can take on a larger value if there is a large target training data set in order to emphasize the training data, and take on a smaller value if there is a small target training data set, in order to emphasize the estimate parameter set 1014 determined using the meta-modeling procedures described above.

Generally, the class specific parameters 1020 address differences between classes of data in the target data set. As described throughout this disclosure, embodiments of the present disclosure can be used for anomaly detection application. In such cases, there may be two classes of data: normal data, and anomalous data. For some many data sets, these two classes may be unbalanced, e.g., there may be considerably fewer anomalous data records than normal data records. This class imbalance can pose a problem for machine learning. Often when a machine learning model is trained using an unbalanced data set, the machine learning model learns to classify most (if not all) input data as belonging to the majority class (sometimes referred to as the “head” class). This leads to a high positive rate when classifying data belonging to the majority class, but a very low positive rate when classifying data belonging to the minority class (sometimes referred to as the “tail” class). The class specific parameters 1020 can be used to weigh target training data in order to emphasize identifying elements of the minority class (e.g., the anomalies), improving the classification rate for anomalies.

Using the estimate parameter set 1014, the out of distribution parameters 1016, the task specific parameters 1018, and the class specific parameters 1020, a computer system can train the target model using the target model parameter formula 1010, along with model training techniques such as those described in the reference above. This can result in a trained target model with a target model parameter set 1012. The trained target model can then be used to classify unlabeled target data as normal or anomalous. As an example, the trained target model can be used to classify real-time transaction data as normal or fraudulent.

### E. Computer System

Any of the computer systems mentioned herein may utilize any suitable number of subsystems. Examples of such subsystems are shown in FIG. 11 in computer system 1100. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 11 are interconnected via a system bus 1112. Additional subsystems such as a printer 1108, keyboard 1118, storage device(s) 1120, monitor 1124 (e.g., a display screen, such as an LED), which is coupled to display adapter 1114, and others are shown. Peripherals and input/output (I/O) devices, which couple to I/O controller 1102, can be connected to the computer system by any number of means known in the art such as input/output (I/O) port 1116 (e.g., USB, FireWire®). For example, I/O port 1116 or external interface 1122 (e.g. Ethernet, Wi-Fi, etc.) can be used to connect computer system 1100 to a wide area network such as the Internet, a mouse input device, or a scanner. The interconnection via system bus 1112 allows the central processor 1106 to communicate with each subsystem and to control the execution of a plurality of instructions from system memory 1104 or the storage device(s) 1120 (e.g., a fixed disk, such as a hard drive, or optical disk), as well as the exchange of information between subsystems. The system memory 1104 and/or the storage device(s) 1120 may embody a computer readable medium. Another subsystem is a data collection device 1110, such as a camera, microphone, accelerometer, and the like. Any of the data mentioned herein can be output from one component to another component and can be output to the user.

A computer system can include a plurality of the same components or subsystems, e.g., connected together by external interface 1122, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components.

A computer system can include a plurality of the components or subsystems, e.g., connected together by external interface or by an internal interface. In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer or other suitable display for providing any of the results mentioned herein to a user.

Any of the methods described herein may be totally or partially performed with a computer system including one or more processors, which can be configured to perform the steps. Thus, embodiments can be involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the invention. However, other embodiments of the invention may be involve specific embodiments relating to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications and description mentioned herein are incorporated by reference in their entirety for all purposes. None is admitted to be prior art.

1. A method for training a target model to classify a plurality of target data values as normal or anomalous, the method comprising performing, by a computer system:
generating using one or more source data sets, a plurality of source sub-sets, wherein the one or more source data sets comprise a plurality of source data values, wherein each source sub-set comprises a sub-set of source data values from the plurality of source data values, and wherein the source data values are labeled;
training a plurality of sub-models corresponding to the plurality of source sub-sets to classify the plurality of source data values in the plurality of source sub-sets, thereby producing a plurality of loss functions, the plurality of loss functions relating a plurality of performance metrics to a plurality of sub-model parameter sets, wherein each performance metric of the plurality of performance metrics and each sub-model parameter set of the plurality of sub-model parameter sets corresponds to a sub-model of the plurality of sub-models;
determining, based on the plurality of loss functions, an estimate parameter set; and
training the target model using a target data set and the estimate parameter set, thereby generating a target parameter set corresponding to the target model, wherein training the target model enables the target model to be used to classify the plurality of target data values as normal or anomalous.

2. The method of claim 1, wherein the plurality of sub-models are trained in parallel using a plurality of processors, and wherein the method further comprises dividing the plurality of sub-models among the plurality of processors.

3. The method of claim 1, wherein the plurality of sub-models comprise a plurality of sub-task models, each sub-task model of the plurality of sub-task models associated with a sub-task of a plurality of sub-tasks, each sub-task of the plurality of sub-task comprising classifying source data values of a corresponding source sub-set as normal or anomalous, and wherein the target model comprises a target task model, the target task model associated with a target task comprising classifying the plurality of target data values as normal or anomalous.

4. The method of claim 1, wherein each performance metric of the plurality of performance metrics comprises a loss metric or error metric, the loss metric or error metric measuring the performance of a corresponding sub-model based on a difference between a plurality of labels and a plurality of classifications, wherein the plurality of labels and the plurality of classifications correspond to a source sub-set corresponding to the corresponding sub-model.

5. The method of claim 1, wherein training the target model using the target data set and the estimate parameter set is accomplished using a Bayesian meta-learning process comprising:
determining a normal data class weight and an anomalous data class weight using a Softmax function;
determining a plurality of task learning rates, wherein a relative value of each task learning rate of the plurality of task learning rates is proportional to a size of the target data set;
determining a task distribution modifier; and
generating the target parameter set using the normal data class weight, the anomalous data class weight, the plurality of task learning weights, the task distribution modifier, and the target data set.

6. The method of claim 1, wherein:
the plurality of source data values comprise a plurality of source event data values corresponding to a plurality of source events, the plurality of source events comprising a plurality of normal source events and a plurality of anomalous source events, wherein a normal source event comprises a source event at which no fraud took place and an anomalous source event comprises a source event at which fraud took place; and
the plurality of target data values comprise a plurality of target event data values corresponding to a plurality of target events, the plurality of target events comprising a plurality of normal target events and a plurality of anomalous target events, wherein a normal target event comprises a target event where no fraud took place, and an anomalous target event comprises a target event where fraud took place.

7. The method of claim 6, wherein the plurality of source events comprise a plurality of source real-time transactions, and wherein the plurality of target events comprises a plurality of target real-time transactions.

8. The method of claim 1, wherein:
the plurality of sub-models corresponding to the plurality of source sub-sets are trained using a plurality of source unified color maps and a plurality of source labels, each source unified color map of the plurality of source unified color maps and each source label of the plurality of source labels corresponding to a source data value of the plurality of source data values in the plurality of source sub-sets;
the target model is trained using a plurality of target unified color maps and a plurality of target labels, each target unified color map of the plurality of target unified color maps and each target label of the plurality of target labels corresponding to a target data value of the target data set;
the method further comprising, prior to training the plurality of sub-models corresponding to the plurality of source sub-sets to classify the plurality of source data values in the plurality of source sub-sets:
performing a first feature extraction process on each source data value of the plurality of source data values, thereby producing a plurality of source feature vectors, and
generating the plurality of source unified color maps using the plurality of source feature vectors, such that each source unified color map of the plurality of source unified color maps corresponds to a source feature vector of the plurality of source feature vectors; and
the method further comprising, prior to training the target model:
performing a second feature extraction process on each target data value of the plurality of target data values, thereby producing a plurality of target feature vectors, and
generating the plurality of target unified color maps using the plurality of target feature vectors, such that each target unified color map of the plurality of target unified color maps corresponds to a target feature vector of the plurality of target feature vectors.

9. The method of claim 8, wherein each source feature vector comprises a plurality of source feature values, and wherein generating the plurality of source unified color maps using the plurality of source feature vectors comprises, for each source feature vector of the plurality of source feature vectors:
determining a width dimension, a height dimension, and a depth dimension based on a number of feature values in the source feature vector;
generating one or more value maps comprising a plurality of value cells, wherein a number of value maps in the one or more value maps is equal to the depth dimension, wherein a width of each value map of the one or more value maps is equal to the width dimension, and wherein a height of each value map of the one or more values maps is equal to the height dimension;
populating the one or more value maps using the plurality of source feature values;
generating, based on the one or more value maps, one or more color maps comprising a plurality of color cells, each color cell of the plurality of color cells associated with a color value corresponding to a feature value, wherein each color map is associated with a particular color channel; and
generating a source unified color map, the source unified color map comprising the one or more color maps, thereby generating the plurality of source unified color maps.

10. The method of claim 8, wherein each target feature vector comprises a plurality of target feature values, and wherein generating the plurality of target unified color maps using the plurality of target feature vectors comprises, for each target feature vector of the plurality of target feature vectors:
determining a width dimension, a height dimension, and a depth dimension based on a number of feature values in the target feature vector;
generating one or more value maps comprising a plurality of value cells, wherein a number of value maps in the one or more value maps is equal to the depth dimension, wherein a width of each value map of the one or more value maps is equal to the width dimension, and wherein a height of each value map of the one or more value maps is equal to the height dimension;
populating the one or more value maps using the plurality of target feature values;
generating, based on the one or more value maps, one or more color maps comprising a plurality of color cells, each color cell of the plurality of color cells associated with a color value corresponding to a feature value, wherein each color map is associated with a particular color channel; and
generating a target unified color map, the target unified color map comprising the one or more color maps, thereby generating the plurality of target unified color maps.

11. A method comprising performing, by a computer system:
receiving a data set comprising a plurality of data values, wherein the plurality of data values are labeled;
performing a feature extraction process on the plurality of data values, thereby producing a plurality of data vectors, each data vector comprising a plurality of feature values;
for each data vector of the plurality of data vectors:
determining a width dimension, a height dimension, and a depth dimension based on a number of feature values in the plurality of feature values in the data vector;
generating one or more value maps comprising a plurality of value cells, wherein a number of value maps in the one or more value maps is equal to the depth dimension, wherein a width of each value map of the one or more values maps is equal to the width dimension, and wherein a height of each value map of the one or more value maps is equal to the height dimension;
populating the one or more value maps using the plurality of feature values by assigning the plurality of feature values to the plurality of value cells;
generating, based on the one or more value maps, one or more color maps comprising a plurality of color cells, each color cell of the plurality of color cells associated with a color value corresponding to a feature value, wherein each color map is associated with a particular color channel of one or more color channels;
generating a unified color map, the unified color map comprising the one or more color maps, thereby generating a plurality of unified color maps; and
training a machine learning model using the plurality of unified color maps and a plurality of labels corresponding to the plurality of data values.

12. The method of claim 11, further comprising, after determining the width dimension, the height dimension, and the depth dimension based on the number of feature values:
generating one or more dummy feature values; and
including the one or more dummy feature values in each data vector.

13. The method of claim 11, wherein a product of the width dimension, the height dimension, and the depth dimension is equal to the number of feature values in each feature vector, and wherein the width dimension is equal to the height dimension.

14. The method of claim 11, wherein the width dimension is at least two, the height dimension is at least two, and the depth dimension is at least one.

15. The method of claim 11, wherein the one or more color channels comprise a cyan color channel, a magenta color channel, a yellow color channel, and a black color channel.

16. The method of claim 11, wherein the one or more color channels comprise a red color channel, a green color channel, and a blue color channel.

17. The method of claim 16, wherein the one or more color channels additionally comprise an alpha channel.

18. The method of claim 11, wherein populating the one or more value maps using the plurality of feature values comprises, for each feature value of the plurality of feature values:
determining a corresponding value map of the one or more value maps, the corresponding value map of the one or more value maps determined in order to associate the feature value with similar feature values within the corresponding value map;
determining a row of a plurality of rows in the corresponding value map, the row determined in order to associate the feature value with similar feature values within the row;
determining a column of a plurality of columns in the corresponding value map, the column determined based on a temporal characteristic of the feature value; and
assigning the feature value to a corresponding value cell of the corresponding value map, the corresponding value cell defined by the row and the column.

19. The method of claim 18, wherein the feature value corresponds to a number of events that take place over a corresponding time period, wherein the temporal characteristic of the feature value is the corresponding time period, wherein each column of the plurality of columns corresponds to a time period of a plurality of time periods, and wherein the column corresponds to the corresponding time period.

20. A computer system comprising:
a processor; and
a non-transitory computer readable medium coupled to the processor, the non-transitory computer readable medium comprising code, executable by the processors for implementing a method for training a target model to classify a plurality of target data values as normal or anomalous, the method comprising:
generating using one or more source data sets, a plurality of source sub-sets, wherein the one or more source data sets comprise a plurality of source data values, wherein each source sub-set comprises a sub-set of source data values from the plurality of source data values, and wherein the source data values are labeled;
training a plurality of sub-models corresponding to the plurality of source sub-sets to classify the plurality of source data values in the plurality of source sub-sets, thereby producing a plurality of loss functions, the plurality of loss functions relating a plurality of performance metrics to a plurality of sub-model parameter sets, wherein each performance metric of the plurality of performance metrics and each sub-model parameter set of the plurality of sub-model parameter sets corresponds to a sub-model of the plurality of sub-models;
determining, based on the plurality of loss functions, an estimate parameter set; and
training the target model using a target data set and the estimate parameter set, thereby generating a target parameter set corresponding to the target model, wherein training the target model enables the target model to be used to classify the plurality of target data values as normal or anomalous.
